(19) United States
(12) Patent Application Publication
(10) Pub. No.: US 2007/0299785 A1
(43) Pub. Date: Dec. 27, 2007

(54) Method of searching and classifying funds

(76) Inventor: Dylan Tullberg, Santa Monica, CA (US)

Correspondence Address: CISLO & THOMAS, LLP, 233 WILSHIRE BLVD, SUITE 900, SANTA MONICA, CA, 90401-1211, US

(21) Appl. No.: 11/473,854

(22) Filed: Jun. 23, 2006

(51) Int. Cl. G06Q 40/00

(52) U.S. Cl. 705/36 R

(57) ABSTRACT

A method of searching and classifying of funds and their related investment information, especially for online use, involving: providing a software program for facilitating performance of a search; providing a fields list; and providing a starting list, the search being of a type such as a user-provided holdings comparison and a user-defined category search, the fields list providing step involving a plurality of tables, each table having a data set concerning individual publicly traded funds, the tables providing step involving the data set including at least one data item such as a plurality of holding names, a plurality of holding types, a plurality of fund types, a plurality of ticker symbols, a plurality of international securities identification numbers, a plurality of share numbers, and a plurality of categories, the starting list providing step involving a step such as manually entering information, uploading information from a spreadsheet, and selecting information from the data set, the data set providing step involving the plurality of holding types as a stock, a bond, and a stock option, and the data set providing step involving the plurality of fund types such as a mutual fund, an index fund, an exchange-traded fund.

### TECHNICAL FIELD

The present invention technically relates to methods of online searching information. More particularly, the present invention technically relates to methods of online searching investment information. Even more particularly, the present invention technically relates to methods of online searching fund investment information.

### BACKGROUND ART

Various business methods have been used for online searching investment information. One related art method involves screening equities and a corresponding system for screening those equities. The method includes the steps of ranking a plurality of equity parameters to normalize each equity parameter with respect to each other equity parameter. User preferences respecting the weight to be given equity parameters of interest are received; and the ranked equity parameters of interest are weighted based upon the received user preferences to assign a score to each equity. A scored equity appropriate for the user preferences may then be selected.

In particular, this related art method involves a system for screening equities which includes a server system configured to receive equity parameters for a plurality of equities and user preferences respecting the weight to be given equity parameters of interest. A database communicates with the server system to store the received equity parameters; and a central processing unit communicates with the database to rank the received equity parameters; and a central processing unit communicates with the data base to rank the received equity parameters in order to normalize each equity parameter with respect to each other equity parameter. The central processing unit is instructed to weight the ranked equity parameters of interest based upon the received user preferences in order to assign a score to each equity and to select at least one scored equity appropriate for the user preferences.

Another related art method involves computer-implemented methods and systems for supporting financial decisions which are operated by searching for securities or portfolios similar to one or more reference securities or portfolios; alerting a user when the number of references to a selected financial instrument on at least one selected web site exceeds a predetermined amount; and/or enabling a user to graphically display financial entities and dynamic relationships between them. This related art method permits users to search for similar securities by defining similarity criteria, each with an associated relative weight. The user can specify similarity criteria such as market valuation, balance sheet strength, operating history, price performance, growth, profitability, dividend potential, market capitalization, or entity size. The user can also define a “search metric” for measuring the “similarity distance” between the user-specified security and each of the similar securities being searched. The search metric may be a weighted Euclidean distance.

The related system finds similar stocks by calculating the square of the distance of each attribute as compared between the two stocks. The system then sorts the similar securities by applying a user-defined priority list for display to the user. The user may also search for dissimilar stocks within a defined set of stocks. This invention combines multiple views, e.g., two views may be used together by combining the attributes and weights of each view. Another way of employing multiple views is by using one view for finding similar securities and subsequently using another view for reverse-sorting, i.e., using the maximum Euclidean distance for obtaining dissimilarity. The search results are filtered by additional criteria such as risk or compliance measures.

Another related art method involves the ranking of user preferences. The searched item is categorized in classes; and the sort mechanism gives the user a list of attributes of the item. The user selects one or more attributes of the item from a list. Alternatively, the user edits the list of attributes. Each attribute is assigned a value for use in displaying the results of the search in real time. The value of each attribute may not exceed a certain threshold; and if it does, the search mechanism normalizes it accordingly. The results are further sorted in real time by either changing the value of one or more attributes or by clicking on a heading of an attribute, thereby defining it as the most relevant, or least relevant, attribute from the list of attributes. The user changes the rank of any attribute, thereby refreshing the search results accordingly. If certain attributes or values of attributes constantly change, whether it be the cost of a stock, the wind direction or the wind speed in a city, such values would be refreshed in real time. The user has the option of “shutting-off” the real time update feature, especially when the user feels that the searched items do not involve constantly changing attributes or values or when the user desires to conserve computer resources.

Another related art method involves a database management system for managing a database having a plurality of data files. The system comprises a data file access module for accessing a particular data file for obtaining the content of the data file, for editing the data file, and for restoring the data file; an index analyzing module for analyzing the content of the data file and for generating a descriptive data stream having indices and weight values; an index establishing module for establishing a series of descriptive parameters for the data file according to the analytical results provided by the index analyzing module; a data file searching module for searching the database data files using descriptive parameters; and user-interface for allowing users to input, edit, and delete descriptive parameters for a particular data file.

Another related art system and method exists for creating a user profile and for using the user profile to order search results returned by a search engine. The user profile is based on search queries submitted by a user, the user's specific interaction with the documents identified by the search engine, and personal information provided by the user. Generic scores associated with the search results are modulated by the user profile to measure their relevance to a user's preference and interest. The search results are reordered accordingly so that the most relevant results appear on the top of the list. User profiles can be created and/or stored on the client side or the server side of a client-server network environment. This invention involves a plurality of tables, wherein the rightmost column of each table of the plurality stores the rank, i.e., a computed score, of a document when the document is evaluated using one specific type of user profile. A user profile rank can be determined by combining the weights of the items associated with a document. A category-based or topic-based profile rank is computed.

Another related art system and method exists for generating a search result list of experts, substantially in real time, in response to a search request from a user who is using a computer network. The system includes an updateable and searchable database of expert profiles, wherein the attributes of each expert are stored within the profiles. The system receives search requests from users and applies a weight designated by the user to attributes of the expert as part of the search. This invention generates a search result list, substantially in real time, in response to a search request from a user. A computer network is used to maintain a database of experts. The user makes a search request that is sent to the database. Weights that are designated by the user are applied to various attributes of the desired expert; and a list of relevant experts is displayed. The displayed expert list is ranked according to the user's parameters, a ranking algorithm, or any other useful criteria.

Another related art method involves a tool for creating enhanced investment portfolios across any asset or combination of assets by combining investment rules based on investor-specific objectives. The tool comprises a single platform which allows aggregation of multiple decisions in order for the investor to compare and contrast investment recommendations across all parts of the investment decision process. The tool uses terms “strategy” and “investment strategy” for combining one or more rules, possibly with variable weights assigned to each rule, that are applicable at any level in an investment portfolio. The strategy allows for trading among at least two assets. One aspect of this invention uses multiple objectives via an assigned hierarchy or weighing for developing single scores, ratings, and rankings in order to facilitate making choices among various strategies.

Another related art method involves a computer-implemented management process in the field of high yield corporate bond financial markets, comprising five distinct steps: (1) researching the financial market under evaluation for obtaining all the necessary market business information, thereby providing obtained business information; (2) filtering the obtained market business information, thereby providing filtered business information; (3) entering and sub-scoring the filtered business information, thereby providing sub-scored business information; (4) scoring the sub-scored business information, thereby providing scored business information; and (5) obtaining evaluation results, comprising the scored business information, in a hardcopy or terminal display of recommendations.

In particular, the evaluation process is mapped onto a general scoring process. The determinants to be considered are first defined, e.g., investment banks; and the sub-processes are defined by examining the determinants. The dependencies between the defined determinants are then identified. The determinants are weighted to define their relative importance. This weighting is based on a preference matrix. The determinants are analyzed and scored.

However, these related art business methods and systems, involving securities, do not provide any online searching as to the particulars of fund investments. Thus, a long-felt need is seen to exist for a method of searching and classifying of funds and their related investment information, especially for online use.

### DISCLOSURE OF THE INVENTION

The present invention provides a solution to the related art problems and involves a method of searching and classifying of funds and their related investment information, especially for online use. The present method also involves an approach which assists investors in discovering and comparing funds, wherein the funds comprise a form of collective investment that pools money from a plurality of investors and subsequently invests the money in investment forms such as stocks, bonds, money market instruments, and other securities. Examples of these funds include mutual funds, index funds, and exchange traded funds. In the present invention, holdings include stocks, bonds, money market instruments, e.g., short-term money market instruments, and other securities. The industry categories used in the present invention are the Global Industries Classification Standards (GICS) for categorizing individual holdings within the funds, wherein the gleaned data includes the complete percentage for each GICS represented in the fund, the Standard Industrial Classification (SIC), a government system for classifying industries using a four-digit code, and the North American Industry Classification System (NAICS), a business and government system for classifying and measuring economic activity in North America which is steadily replacing the SIC system.

The present method of searching and classifying funds comprises the steps of: providing a software program for facilitating performance of at least one search; providing a fields list; and providing a starting list, wherein the at least one search is selected from a group consisting essentially of a user-provided holdings comparison and a user-defined category search, wherein the fields list providing step comprises the step of providing a plurality of tables, each table having a data set concerning individual publicly traded funds, wherein the tables providing step comprising the step of providing the data set to include at least one data item being selected from a group consisting essentially of a plurality of holding names, a plurality of holding types, a plurality of fund types, a plurality of ticker symbols, a plurality of international securities identification numbers, a plurality of share numbers, and a plurality of categories, wherein the starting list providing step comprises at least one step such as manually entering information, uploading information from a spreadsheet, and selecting information from the data set, wherein the data set providing step comprises providing the plurality of holding types as at least one holding type such as a stock, a bond, and a stock option, and wherein the data set providing step comprises providing the plurality of fund types as at least one fund type such as a mutual fund, an index fund, an exchange-traded fund. Other features of the present invention are disclosed, or are apparent, in the section entitled “Mode(s) for Carrying-Out the Invention,” disclosed, infra.

### BRIEF DESCRIPTION OF THE DRAWING

For better understanding of the present invention, reference is made to the below-referenced accompanying Drawing. Reference numbers refer to the same or equivalent parts of the present invention throughout the several figures of the Drawing.

FIG. 1 is a schematic representation of a holding list in relation to a funds holdings search, on an exemplary web page, in accordance with the present invention.

FIG. 2 is a schematic representation of a category list in relation to a funds industry holdings search, on an exemplary web page, in accordance with the present invention.

FIG. 3 is a schematic representation of a holding list and a category list in relation to a combined industry category and holdings search, on an exemplary web page, in accordance with the present invention.

FIG. 4 is an overview flow chart showing a sequence of steps of the user authorization and registration stage, in accordance with the present invention.

FIG. 5 is a schematic representation of a web page for selecting basic fund types with additional criteria, by example only, in accordance with the present invention.

FIG. 6 is a schematic representation of a web page for searching funds by item types, by example only, in accordance with the present invention.

FIG. 7A is a tabular representation of the step of preparing data for hierarchy order during the step of preparing the background data by the software program, in accordance with the present invention.

FIG. 7B is a tabular representation of an original order in the step of preparing data for ratings order during the step of preparing the background data by the software program, in accordance with the present invention.

FIG. 7C is a tabular representation of a new order in the step of preparing data for ratings order during the step of preparing the background data by the software program, in accordance with the present invention.

FIG. 8A is a tabular representation of search results as would be shown on a web page, corresponding to the hierarchy order, as found using the software program, by example only, in accordance with the present invention.

FIG. 8B is a tabular representation of search results as would be shown on a web page, corresponding to the revised order, i.e., the ratings order, as found using the software program, by example only, in accordance with the present invention.

FIG. 9 is a tabular representation of the search result for a single fund as would be shown on a web page, as found using the software program, by example only, in accordance with the present invention.

FIG. 10A is an overview flow chart for the funds holdings search in relation to the fund industry category search, in accordance with the present invention.

FIG. 10B is a flowchart showing the steps from entering data by the user to processing the user's entered data, in accordance with the present invention.

FIG. 10C is a flowchart showing the steps of searching the database to displaying the search results, in accordance with the present invention.

FIG. 11A is a schematic representation of a web page for the user's exercising an option for comparing two funds, by example only, in accordance with the present invention.

FIG. 11B is a schematic representation of a web page for the user's exercising an option for comparing a fund's data as existing between two user-defined dates, by example only, in accordance with the present invention.

FIG. 12a is a flow chart showing the detailed method steps in the step of showing a selected fund's detailed information, in accordance with the present invention.

FIG. 12b is a flow chart showing the detailed method steps of a holding churn in relation to a category churn, in accordance with the present invention.

FIG. 13 is a flow chart showing the detailed method steps involved for comparing two funds and for comparing one fund between two dates, in accordance with the present invention.

### MODE(S) FOR CARRYING-OUT THE INVENTION

In general the present method M involves a user, e.g., a prospective investor or an investment broker, entering a list of holdings into a software program via a form, e.g., an online form, of the present invention. The list of holdings comprises a few of the user's favorite publicly traded companies. The software program searches through the holdings and finds the funds which contain the most “matches.” The software program sorts the search results and generates a list of results, i.e., a desired holdings list, in an order of descending “matches.” A searchable “item” includes a single fund holding or a “category.” An “item %” or “item percentage” is the ratio of any item in relation to the entire fund. The present method M comprises presenting options to limit the scope of the fund criteria, wherein the fund criteria includes the fund type, the fund expenses, the fund's net asset value(s) (NAV), and other performance data, by example only. Standard fund criteria are as follows: a fund type, such as an exchange-traded fund (ETF) and an index fund, a minimum initial investment, a “front-end” load, a purchase fee, a “back-end” load, an exchange fee, an account fee, annual operating expenses for a fund, a date for the most recent data (the updated data), a total expense ratio, a NAV, and a name of the entity performing the update.

In addition to generating the desired holdings list, the software program allows the user to initially designate a preference or a weight with respect to each holding in the holdings list using a technique such as respectively specifying a hierarchy of importance in the order of the entered holdings list, i.e., “preferring,” and associating a percentage to each holding in the holdings list, i.e., “weighting.” With either technique, the software program assigns a desired percentage of importance for each holding. In the case of the hierarchy-specifying technique, the holdings list is provided with descending percentage importance; and in the case of percentage-associating technique, the undesignated holdings are assigned the same percentage importance while the designated holdings are provided with higher percentages of importance. These techniques enhance and refine the search results.

Alternatively, the present invention software program of the present method M provides for searching funds by matching industry categories. A user, e.g., a prospective investor or an investment broker, enters a list of industry categories into the software program via a form, e.g., an online form, of the present invention. The list of industry categories comprises a few of the user's target industry categories. The software program performs a search for the funds that most closely match this industry categories list. The software program sorts the search results and generates a list of results, i.e., a desired industry categories list, in an order of descending “matches.”

In addition to generating the desired industry categories list, the software program allows the user to initially designate a preference or a weight with respect to each industry category in the industry categories list using a technique such as respectively specifying a hierarchy of importance in the order of the industry categories list, i.e., “preferring,” and associating a percentage to each industry category in the industry categories list, i.e., “weighting.” With either technique, the software program assigns a desired percentage of importance for each industry category. In the case of the hierarchy-specifying technique, the industry categories list is provided with descending percentage importance; and in the case of percentage-associating technique, the undesignated industry categories are assigned the same percentage importance while the designated industry categories are provided with higher percentages of importance. These techniques enhance and refine the search results.

The method M accommodates three user levels, i.e., “regular” users, fund managers, and program administrators. The software program comprises a regular user program which performs a fund holding and category search for a regular user. The software program further comprises a fund manager program which performs a fund holding and category search as well as provides a fund information editing option for a fund manager, wherein the fund information editing option includes a feature for editing holding names, share amounts, category names, and category amounts, a feature for uploading a spreadsheet containing current fund data, and a feature for manually editing individual fund data via an online fillable form and submission technique. The software program further comprises a fund-program administrator program which performs a fund holding and category search, a fund information editing option for a fund-program administrator, and user-information editing option, wherein the fund information editing option includes a feature for editing holding names, share amounts, category names, and category amounts, a feature for uploading a spreadsheet containing current fund data, and a feature for manually editing individual fund data via an online fillable form and submission technique, and wherein the user-information editing option includes a feature for adding user information, a feature for deleting user information, and a feature for editing user information.

The present method M further comprises the step of collecting data such as data from corporate quarterly filings that are required by the Securities and Exchange Commission (SEC), data from third-party sources, and updateable data from authorized fund management personnel. The corporate quarterly filings data include information gleaned, via a computer, from an SEC Form N-Q which may be subsequently manually edited for use by the present software program. The third-party sources data include real-time information gleaned from sources such as Lipper™, Reuters™, and Morningstar™, such data gathering being in compliance with federal securities regulations. New data is collected, e.g., manually; and old data is archived in the database. Interim data may be collected by direct updating by a registered entity having special permission, wherein the interim data includes intra-quarterly data, and by manually gathering data from the most recently posted corporate data, such as would be found on a corporate web site in compliance with the site's policy and property rights. The method M also comprises using the archived data for providing comparisons in fund metrics as a function of a plurality of dates.

The present method M comprises providing the database having a set of relevant data fields, being gleaned from data feeds by either manual entry or automatically via a computer, such as user type data, user authorization data, securities data, company data, fund type data, fund-association-to-company data, fund filing attributes, fund fees, past fund data, industry classification and categories references, fund categories, and fund holdings, in accordance with the present invention. The user type data comprises user-type identification and a user type, such as a regular user, a fund administrator, and a program administrator. The user authorization data comprises user identification, user contact information, and a user-type identification. The securities data comprises security identification, a security name, a ticker, and an ISIN reference. The company data comprises a Central Index Key (CIK) which is a unique company identifier assigned by the SEC, the name of the company, its web URL for its corporate web site, and a location reference for its logo image, if provided by the company. The fund type data comprises a fund type identification, and a fund type name, e.g., mutual, index, EFT, hedge, etc. The fund-association-to-company data comprises fund identification, a fund name, a CIK, a ticker symbol, and a fund type identification. The fund filing attributes comprise a fund identification, a fund name, a fund type identification, the end of fiscal year date for the fund, the SEC reporting period date, the date of company's manual update, the NAV, the location reference for the filing document, the method of making the most recent update, i.e., manually or by quarterly filing, date of entering the updated information, name of user making the update. The fund fees data comprises fund identification, a minimal investment amount, minimum initial investment, a “front-end” load, a purchase fee, a “back-end” load, a redemption fee, an exchange fee, an account fee, annual operating expenses for a fund, and a total expense ratio. The current fund information comprises fund identification, current stock price, date and time “updated,” the current NAV, the turnover, the median market cap, and the manager tenure. The past fund information comprises the und identification, the year-to-date the (YTD) return, the one-year (1-yr.) return, the three-year (3-yr.) return, and the five-year (5-yr.) return. The industry classification and categories reference data comprises the category identification, the GICS code, and the category name. The fund categories data comprises the fund identification, the category name, the category identification (the software program verifies the imported category name for finding the closest match in the category identification, and the percentage of the fund. The fund holdings data comprises the fund identification, the holding name, the security identification (being automatically generated by matching the holding name with the security identification), the number of shares, the market value of the shares, the percentage of the fund (being automatically calculated by dividing the market value of the holding by the net asset value for the given fund.

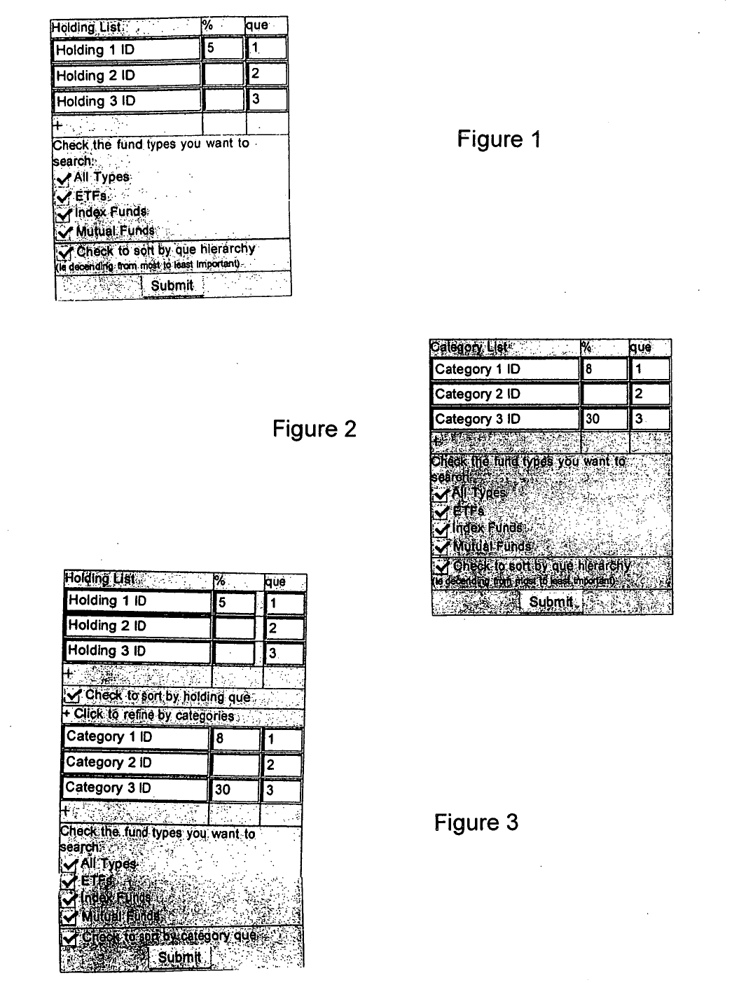

FIG. 1 illustrates, in a schematic representation, a holdings list 100 (basic) in relation to a funds holdings search, on an exemplary web page 1000, in accordance with the present invention. The holdings list 100 comprises at least one field 110 for the user's entry of holdings data 120 which includes identification of items such as stocks, bonds, money market instruments, e.g., short-term money market instruments, and other securities; at least one corresponding field 130 for the user's entry of holdings “percentage-associating” data; at least one corresponding field 140 for the user's entry of holdings “hierarchy-specifying” data; at least one toggle feature 150 for indicating a search option such as all fund types, exchange traded funds, index funds, mutual funds, and hierarchy specification; and a “submit” button 160 for initiating the search.

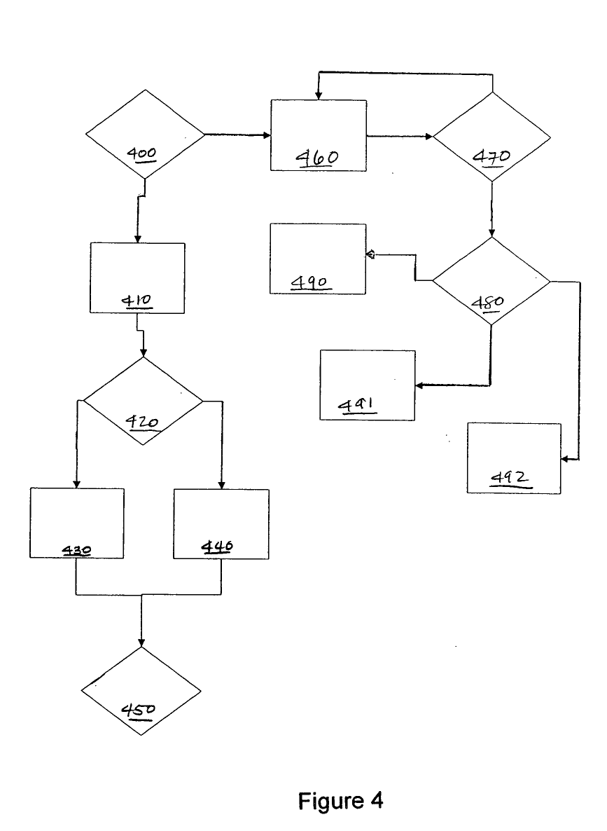

FIG. 2 illustrates, in a schematic representation, an industry categories list 200 (basic) in relation to an industry categories search, on an exemplary web page 2000, in accordance with the present invention. The industry categories list 200 comprises at least one field 210 for the user's entry of industry categories data 220 which includes items such as SIC code and a NAICS code; at least one corresponding field 230 for the user's entry of industry categories “percentage-associating” data; at least one corresponding field 240 for the user's entry of industry categories “hierarchy-specifying” data; at least one toggle feature 250 for indicating a search option such as all fund types, exchange traded funds, index funds, mutual funds, and hierarchy specification; and a “submit” button 260 for initiating the search.

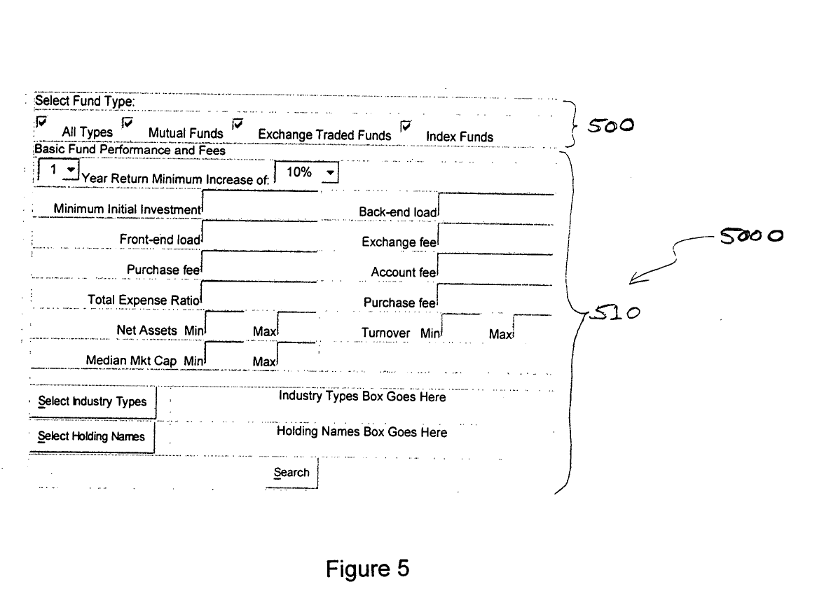

FIG. 3 illustrates, in a schematic representation, a holdings list 100 (basic) and an industry categories list 200 (basic) in relation to a combined industry categories and holdings search, on an exemplary web page 3000, in accordance with the present invention. The holdings list 100 comprises at least one field 110 for the user's entry of holdings data 120 which includes identification of items such as stocks, bonds, money market instruments, e.g., short-term money market instruments, and other securities; at least one corresponding field 130 for the user's entry of holdings “percentage-associating” data; and at least one corresponding field 140 for the user's entry of holdings “hierarchy-specifying” data; at least one toggle feature 150 for indicating a search option such as all fund types, exchange traded funds, index funds, mutual funds, and hierarchy specification; and a “submit” button 160 for initiating the search. The industry categories list 200 comprises at least one field 210 for the user's entry of industry categories data 220 which includes items such as SIC code and a NAICS code; at least one corresponding field 230 for the user's entry of industry categories “percentage-associating” data; at least one corresponding field 240 for the user's entry of industry categories “hierarchy-specifying” data; at least one toggle feature 250 for indicating a search option such as all fund types, exchange traded funds, index funds, mutual funds, and hierarchy specification; and a “submit” button 260 for initiating the search. These two searches are combined as shown on the web page 3000.

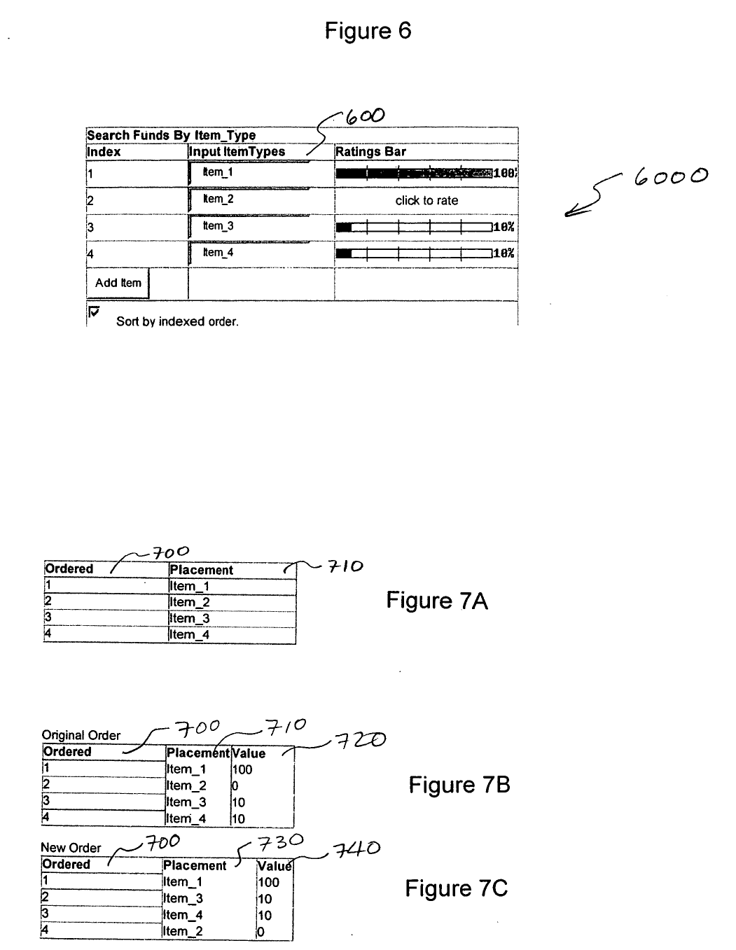

FIG. 4 is an overview flow chart showing a sequence of steps of the user authorization and registration stage, in accordance with the present invention. The user begins by selecting a login screen if such user is already registered or by selecting a registration screen if such user has not already been registered, as indicated by block 400. If the user has selected the registration screen, the software program prompts the user for his/her information, as indicated by block 410, and provides the user with an option for requesting fund manager privilege, as indicated by block 420. If the user requests fund manager privilege, the software program alerts the program administrators and, in turn, requests their approval, as indicated by block 430; and if the user declines fund manager privilege, the software program verifies the user, as indicated by block 440, wherein wither event, if the user is approved, his/her information is stored in the database by the software program, as indicated by block 450. If the user has selected the login screen, the software program verifies whether the user has user information already stored in the database, as indicated by block 470, and if not, provides the user with an opportunity to return to the main menu and then proceed to the registration screen, as indicated by block 460. If the software program verifies that the user information has already been stored in the database, the user type is verified, as indicated by block 480, whereby the software program imparts options such as administrator options, as indicated by block 490, regular user options, as indicated by block 491, and fund manager options, as indicated by block 492.

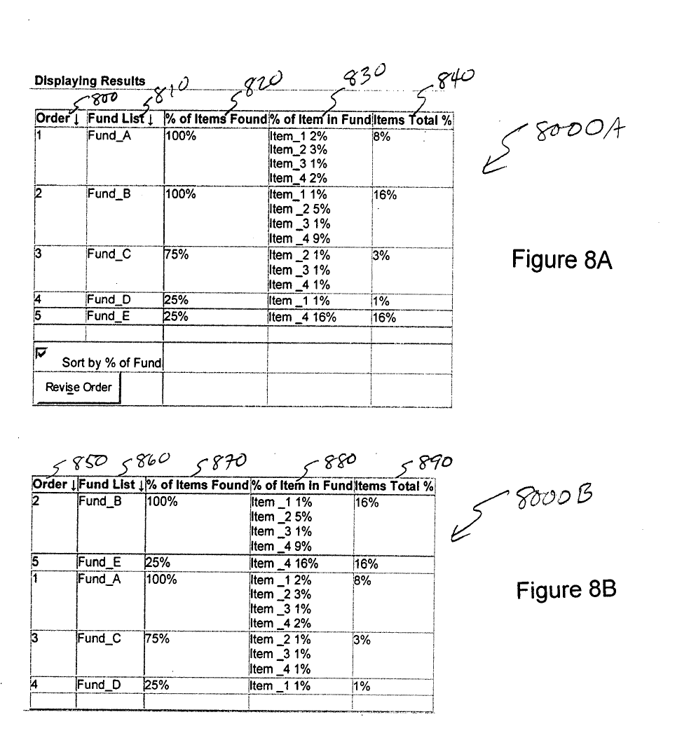

FIG. 5 is a schematic representation of a web page 5000 for selecting basic fund types 500 with additional criteria 510, by example only, in accordance with the present invention.

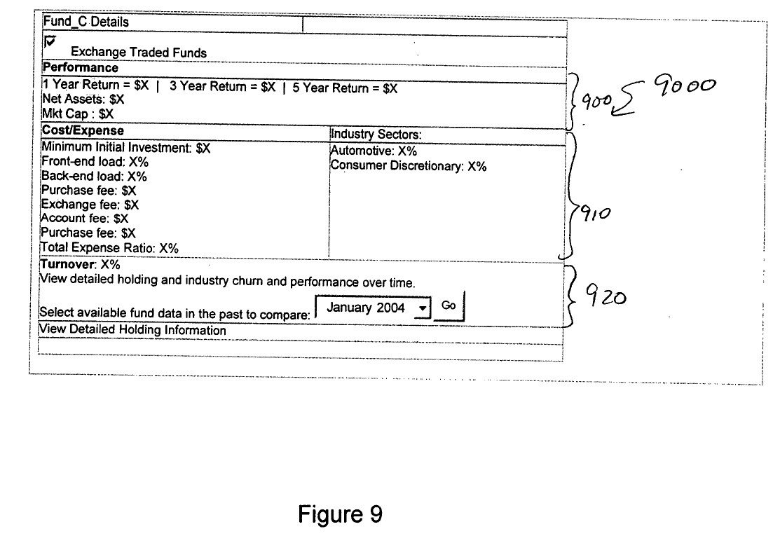

FIG. 6 is a schematic representation of a web page 6000 for searching funds by item types 600, by example only, in accordance with the present invention.

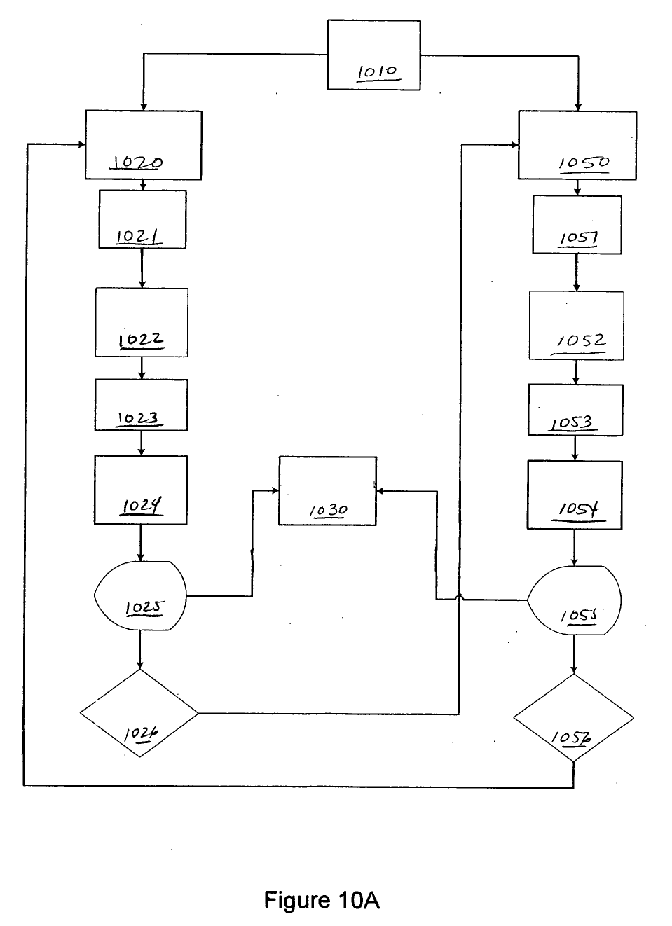

FIG. 7A is a tabular representation of the step of preparing data for hierarchy order during the step of preparing the background data by the software program, in accordance with the present invention. If a sort technique has not been specified by the user, the software program will search and display the funds with the most matching items and will only sort the search results by those funds which have been most recently updated. In the event that the user has specified a hierarchy order, the software program prepares the data by automatically assigning a number based on the index location to each item in the list, wherein the display has a column for order 700 and a column for placement 710.

FIG. 7B is a tabular representation of an original order in the step of preparing data for ratings order during the step of preparing the background data by the software program, in accordance with the present invention. In the event that the user has specified a ratings order, the software program displays the original order comprising a column for order 700, a column for placement 710, and a column for value 720.

FIG. 7C is a tabular representation of a new order in the step of preparing data for ratings order during the step of preparing the background data by the software program, in accordance with the present invention. In the event that the user has specified a ratings order, the software program further displays a new order, i.e., a ratings order, comprising a column for order 700, a column for rated placement 730, and a column for rated value 740.

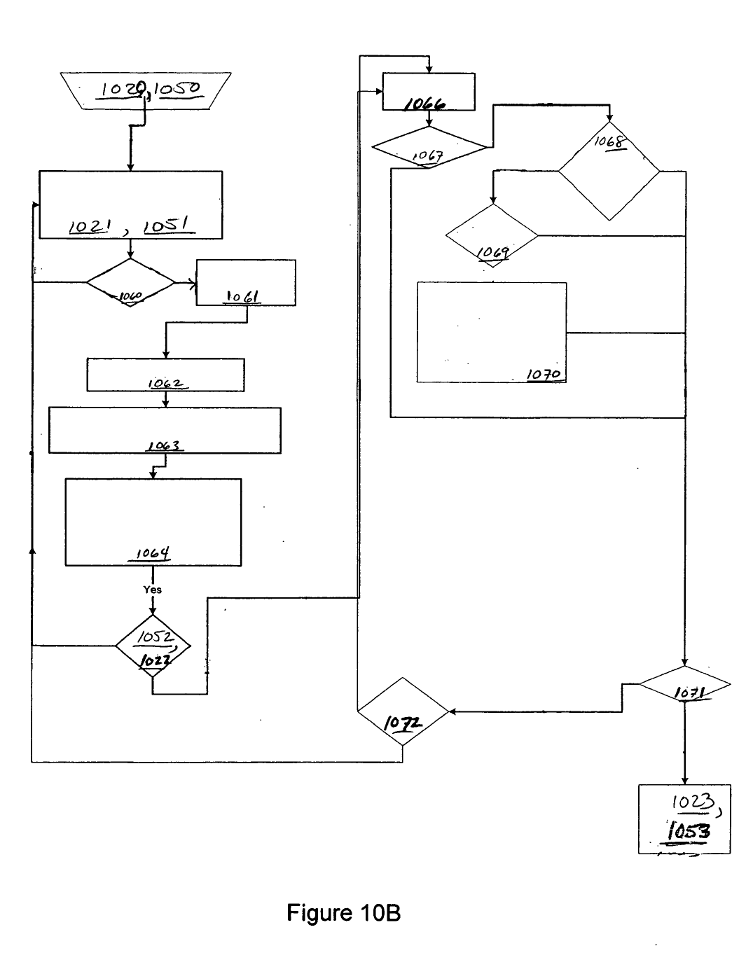

FIG. 8A is a tabular representation of search results as would be shown on a web page 8000A, corresponding to the hierarchy order, as found using the software program, by example only, in accordance with the present invention. In searching using the prepared data, the software program firstly scans each fund for matching items and sorts the list by the most matches. If no weight has been specified, the software program sorts the list again by those having the most matches and the most recently updated information. The software program provides a display of the search results, comprising a column for order 800, a column for funds (a fund list) 810, a column for percentage of items found 820, a column for percentage of items found in the given fund 830, and a column for the total percentage of items 840.

FIG. 8B is a tabular representation of search results as would be shown on a web page, corresponding to the revised order, i.e., the ratings order, as found using the software program, by example only, in accordance with the present invention. Secondly, the software program searches for weighted items in a matched list which involves searching for funds having the highest percentage of items and assigning such items a higher order in the search list, thereby providing a revised order. The search results, as described in connection with FIG. 8A, are revised, thereby showing funds having a greater percentage of specified items and disregarding any specified hierarchy. The software program provides a display of the revised search results, comprising a revised column for order 850, a revised column for funds (a fund list) 860, a revised column for percentage of items found 870, a revised column for percentage of items found in the given fund 880, and a revised column for the total percentage of items 890.

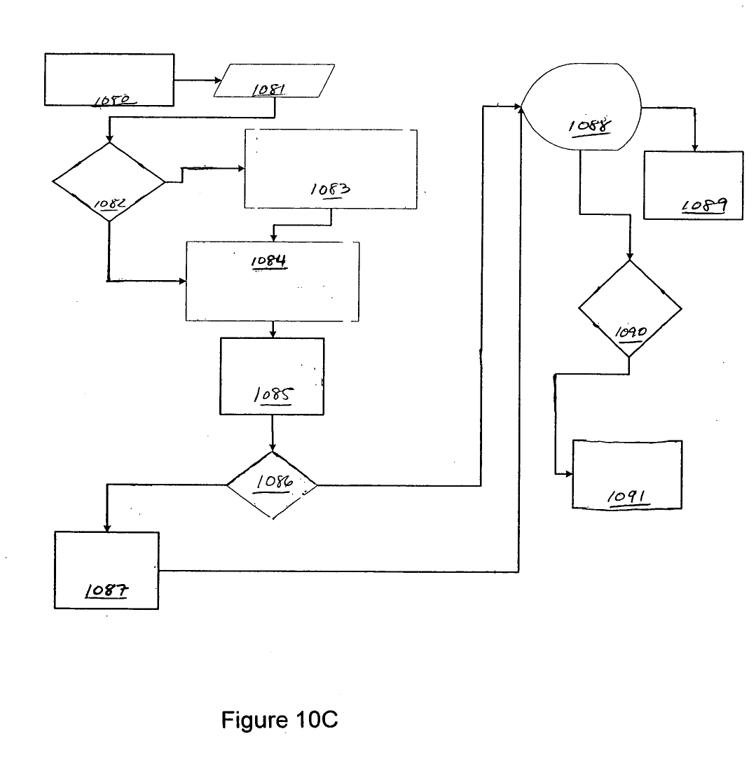

FIG. 9 is a tabular representation of the search result for a single fund, in detail, as would be shown on a web page 9000, as found using the software program, by example only, in accordance with the present invention. The detail comprises fund performance data 900, fund cost and expense data 910, and fund turnover data 920.

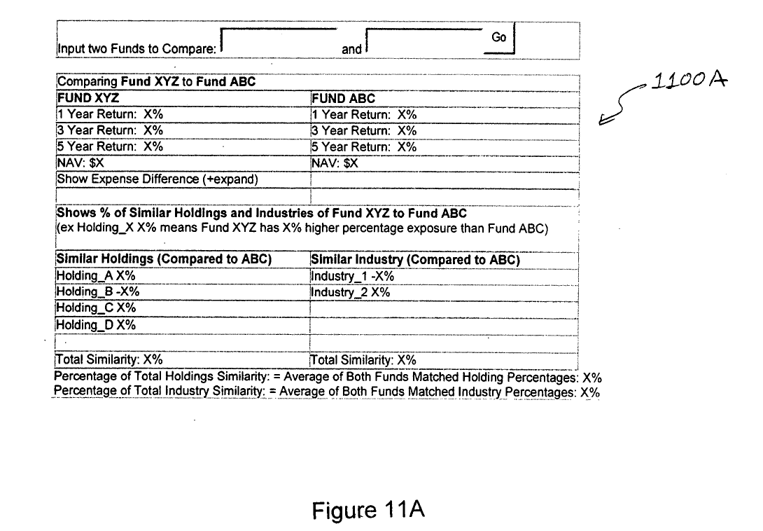

FIG. 10A is an overview flow chart for the funds holdings search branch, as indicated by block 1020, in relation to the fund industry category search branch, as indicated by block 1050, of the software program, in accordance with the present invention. Execution of the software program comprises providing a home page, as indicated by block 1010, from which the user may select a fund holdings search, as indicated by block 1020, or a fund industry category search, as indicated by block 1050. The funds holding search branch comprises taking the user information and submitting the search, as indicated by block 1021, processing the user information, as indicated by block 1022, searching the data, as indicated by block 1023, sorting the search results, as indicated by block 1024, displaying the search results, as indicated by block 1025, and optionally further sorting the search results by industry category, as indicated by block 1026, wherein the search result displaying step, as indicated by block 1025, comprises optionally selecting a fund for showing its detailed information, as indicated by block 1030, and wherein the step of optionally further sorting the search results by industry category, as indicated by block 1026, comprises triggering the fund industry category search, as indicated by block 1050. The industry category search branch, as indicated by block 1050, comprises taking the user information and submitting the search, as indicated by block 1051, processing the user information, as indicated by block 1052, searching the data, as indicated by block 1053, sorting the search results, as indicated by block 1054, displaying the search results, as indicated by block 1055, and optionally further sorting the search results by fund holdings, as indicated by block 1056, wherein the search result displaying step, as indicated by block 1055, comprises optionally selecting a fund for showing its detailed information, as indicated by block 1030, and wherein the step of optionally further sorting the search results by fund holdings, as indicated by block 1056, comprises triggering the fund holdings search, as indicated by block 1020.

FIG. 10B is a flowchart showing the detailed steps performed in the method M, i.e., from entering the user information, as indicated by blocks 1021, 1051, to processing the user's information, as indicated by blocks 1022, 1052, which are analogous in both the fund holdings search, as indicated by block 1020, and the fund industry category search, as indicated by block 1050, in accordance with the present invention. The software program further comprises receiving the user's search selection and the user's entry of a plurality of items or their symbols to be searched, as indicated by blocks 1021, 1051, and querying whether this entered data already exists in the database, as indicated by block 1060. If the entered data does not yet exist in the database, the software program returns the user to the step of entering user data, as indicated by blocks 1021, 1051. If the entered data already exists in the database and if only an item name has been entered, the software program proceeds to the steps of providing a matching symbol, as indicated by block 1061, selecting the fund types, as indicated by block 1062, entering items and weights which includes entering no weight at all, entering a priority associated with the items, and entering a raw percentage, as indicated by block 1063, selecting additional fund criteria such as performance returns, purchase fees, holdings assets, and turnover, as indicated by block 1064, processing the user information, as indicated by blocks 1022, 1052, wherein the user information processing step comprises querying whether all necessary data has been entered by the user. If a necessary field of data is absent in the user information or other user-entered data, the software program returns the user to the step of entering user data, as indicated by blocks 1021, 1051. If all necessary fields of data are present in the user information or other user-entered data, the software program proceeds to the step of processing the user information and other user-entered data, e.g., “feedback,” as indicated by block 1066, and querying whether a priority has been entered, as indicated by block 1067. If a priority has not been entered, the software program proceeds to querying whether an error exists, as indicated by block 1071. If a priority has been entered, the software program proceeds to the step of querying whether any items exist having no entered weight, as indicated by block 1068. If no item is found not to have an entered weight, the software program proceeds to querying whether an error exists, as indicated by block 1071. If an item is found not to have an entered weight, the software program proceeds to querying whether a hierarchical order has been specified, as indicated by block 1069. If a hierarchical order is found to have been specified, the software program proceeds to moving items having an entered percentage to the top of the search list and ordering these items by weight, assigning a descending percentage to each item not having an entered percentage, as indicated by block 1070, and then querying whether any error exists, as indicated by block 1071. If a hierarchical order is not found, the software program proceeds to querying whether an error exists, as indicated by block 1071; and if an error exists, the software program proceeds to the step of correcting the error, as indicated by block 1072. If an error does not exist, the software program proceeds to the database searching step, as indicated by blocks 1023, 1053.

FIG. 10C is a flowchart showing the detailed steps of searching the database, as indicated by block 1023, through the step of displaying the search results, as indicated by block 1025, in accordance with the present invention. The database searching step, as indicated by block 1023, comprises opening data storage, the data storage comprising the database or the data from search results, as indicated by block 1080, thereby providing opened data, as indicated by block 1081, and querying whether any search criteria exist, as indicated by block 1082. If any search criteria are found, the software program proceeds to perform a search using the criteria and the performance data, as indicated by block 1083, and searching for matches, i.e., by searching within matching fund types for fund items that most closely match the user list, as indicated by block 1084. If search criteria is not found, the software program simply searches for matches, i.e., by searching within matching fund types for fund items that most closely match the user list, as indicated by block 1084. In either event, the method M further comprises sorting the search results in descending order of matching, as indicated by block 1085, and querying whether a specified weighting exists, as indicated by block 1086. If a specified weighting exists, the software program proceeds to the step of re-sorting the search results based on the specified weighting, as indicated by block 1087; and if a specified weighting does not exist, the software program proceeds to the step of displaying the search results, as indicated by block 1025. The search results displaying step, as indicated by block 1025, comprises displaying the search results in a table format, as indicated by block 1088, prompting the user for selecting a fund and showing the selected fund's detailed information, as indicated by block 1089. If the user has not selected a particular fund, the software program proceeds to performing a refined search within the search results, as indicated by block 1090, and allowing the user to revise the search options, as indicated by block 1091.

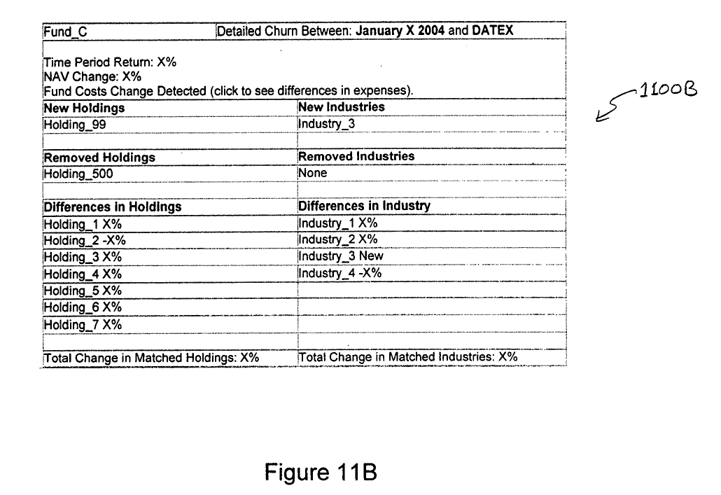

FIG. 11A is a schematic representation of a web page 1100A for the user's exercising an option for comparing two funds, by example only, in accordance with the present invention. In comparing two funds, the user selects those two distinct funds. The software program shows the similarities and differences between the funds on the web page, including similar holdings, matching holding names, the difference in the number of shares and fund percentage of those matched holdings, and the difference in NAV. If a plurality of funds is selected, the funds having the most similarities are displayed first. The web page 1100A shows the percentage difference in holding amounts for the same holdings, the percentage difference in holding amounts for similar categories, and the differences in performance and expense criteria.

FIG. 11B is a schematic representation of a web page 1100B for the user's exercising an option for comparing a fund's data as existing between two user-defined dates, by example only, in accordance with the present invention. The user selects a fund and two distinct dates associated with available fund data. The software program shows the “churn” or turnover of individual holdings, industries, and changes in performance. The software program further compares the names of the holdings as well as the categories and reports any additions (“new holdings” or “new industries”) or deletions (“removed holdings” or “removed industries”).

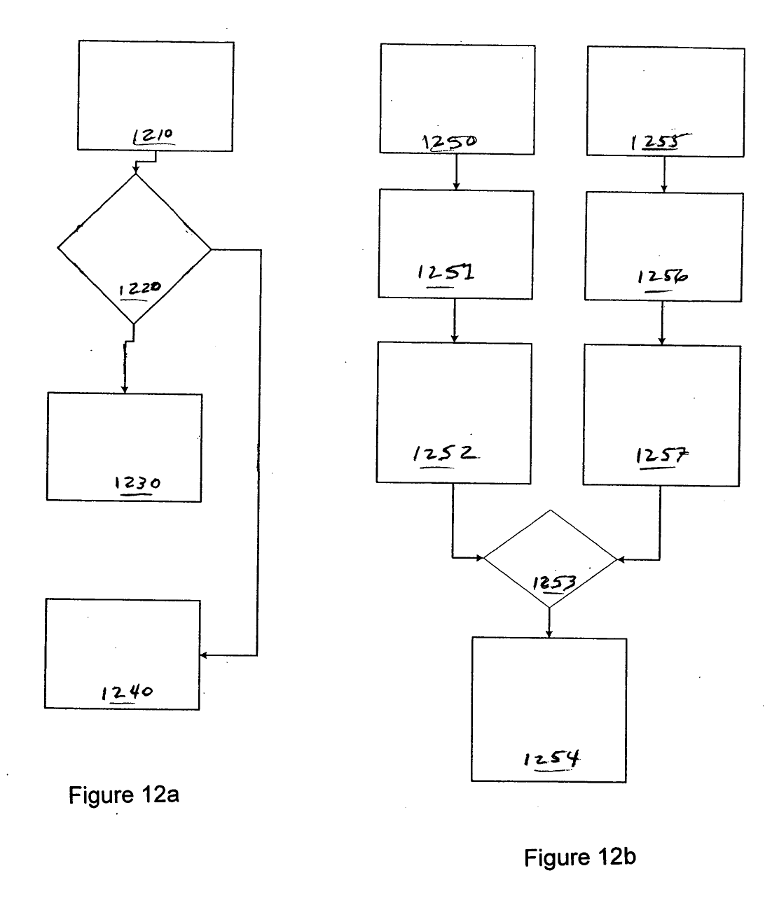

FIG. 12a is a flow chart showing the detailed method steps within the step of showing a selected fund's detailed information, as indicated by block 1030, in accordance with the present invention. The selected fund's detailed information showing step, as indicated by block 1030, comprises displaying a selected fund's holdings, fees, price, performance, and company information, using the fund identification information as indicated by block 1210, and querying whether the user has requested comparing a holding's data as existing between two user-defined dates or whether the user requested comparing a category's data as existing between two user-defined dates, as indicated by block 1220. If the user has requested comparing a holding's data as existing between two user-defined dates, the software program proceeds to perform a holdings churn step between the two dates either with, or without, a performance request, as indicated by block 1230. If the user has requested comparing a category's data as existing between two user-defined dates, the software program proceeds to perform a category churn step by comparing a category between the two dates either with, or without, a performance request, as indicated by block 1240.

FIG. 12b is a flow chart showing the detailed method steps of the holding churn in relation to the category churn, in accordance with the present invention. The holding churn step comprises obtaining available archived fund information, thereby allowing the user to select two available reporting dates for a given fund, as indicated by block 1250, comparing the holding names and corresponding share amounts, as indicated by block 1251, displaying a table of the matched holdings with the share differences, additions, and deletions, as indicated by block 1252, and showing the performance data if requested, as indicated by block 1253, and displaying the performance between the two dates and comparing the difference between the fund's NAV and price, as indicated by block 1254. The category churn step comprises obtaining available archived fund information, thereby allowing the user to select two available reporting dates for a given fund, as indicated by block 1255, comparing the category names and corresponding share percentages, as indicated by block 1256, displaying a table of the matched category with the share differences, additions, and deletions, as indicated by block 1257, and showing the performance data if requested, as indicated by block 1253, and displaying the performance between the two dates and comparing the difference between the fund's NAV and price, as indicated by block 1254.

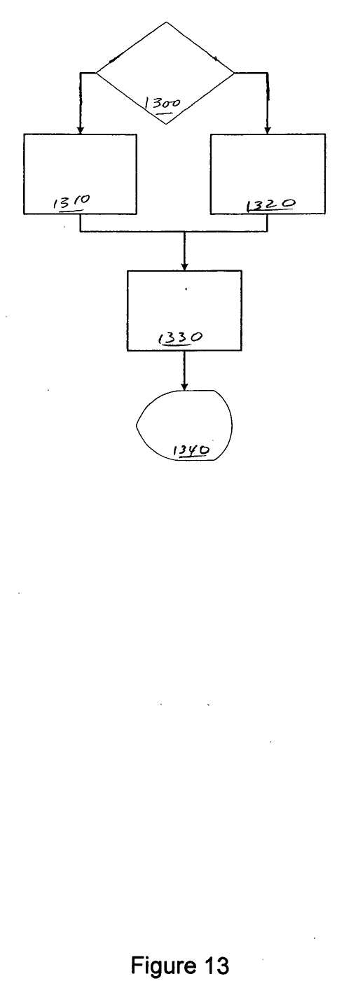

FIG. 13 is a flow chart showing the detailed method steps involved for comparing two funds and for comparing one fund between two dates, in accordance with the present invention. The present method M further comprises the step of querying whether the user desires to compare two different funds or whether the user desires to compare two different dates for a single fund, as indicated by block 1300. If the user desires to compare two different funds, the software program proceeds to the step of selecting two funds in the database, as indicated by block 1310, retrieving both data sets and comparing them, as indicated by block 1330, and displaying the comparison results in a table form, as indicated by block 1340. If the user desires to compare two different dates for a single fund, the software program proceeds to the step of selecting two dates for a single fund in the database, as indicated by block 1320, retrieving both data sets and comparing them, as indicated by block 1330, and displaying the comparison results in a table form, as indicated by block 1340.

Information, as herein shown and described in detail, is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a system, an apparatus, a device, or a method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, that various changes and modifications in form, architecture, logic, method steps, and medium detail may be made without departing from the spirit and scope of the inventions as set forth in the appended claims, should be readily apparent to those of ordinary skill in the art. No claim herein is to be construed under the provisions of 35 U.S.C. § 112, sixth paragraph, unless the element is expressly recited using the phrase “means for.”

### INDUSTRIAL APPLICABILITY

The present invention industrially applies to methods of online searching information. More particularly, the present invention industrially applies to methods of online searching investment information. Even more particularly, the present invention industrially applies to methods of online searching fund investment information.

What is claimed:

1. A method of searching and classifying funds, comprising the steps of:
providing a software program for facilitating performance of at least one search;
providing a fields list; and
providing a starting list.

2. A method, as recited in claim 1, wherein the at least one search is selected from a group consisting essentially of a user-provided holdings comparison and a user-defined category search.

3. A method, as recited in claim 1, wherein the fields list providing step comprises the step of providing a plurality of tables, each table having a data set concerning individual publicly traded funds.

4. A method, as recited in claim 1, wherein the tables providing step comprising the step of providing the data set to include at least one data item being selected from a group consisting essentially of a plurality of holding names, a plurality of holding types, a plurality of fund types, a plurality of ticker symbols, a plurality of international securities identification numbers, a plurality of share numbers, and a plurality of categories.

5. A method, as recited in claim 1, wherein the starting list providing step comprises at least one step being selected from a group consisting essentially of:
manually entering information;
uploading information from a spreadsheet; and
selecting information from the data set.

6. A method, as recited in claim 4, wherein the data set providing step comprises providing the plurality of holding types as at least one holding type selected from a group consisting essentially of a stock, a bond, and a stock option.

7. A method, as recited in claim 4, wherein the data set providing step comprises providing the plurality of fund types as at least one fund type being selected from a group consisting essentially of a mutual fund, an index fund, an exchange-traded fund.

8. A method of searching and classifying funds, comprising the steps of:
providing a software program for facilitating performance of at least one search;
providing a fields list; and
providing a starting list,
wherein the at least one search is selected from a group consisting essentially of a user-provided holdings comparison and a user-defined category search,
wherein the fields list providing step comprises the step of providing a plurality of tables, each table having a data set concerning individual publicly traded funds,
wherein the tables providing step comprising the step of providing the data set to include at least one data item being selected from a group consisting essentially of a plurality of holding names, a plurality of holding types, a plurality of fund types, a plurality of ticker symbols, a plurality of international securities identification numbers, a plurality of share numbers, and a plurality of categories,
wherein the starting list providing step comprises at least one step being selected from a group consisting essentially of:
manually entering information;
uploading information from a spreadsheet; and
selecting information from the data set,
wherein the data set providing step comprises providing the plurality of holding types as at least one holding type selected from a group consisting essentially of a stock, a bond, and a stock option, and
wherein the data set providing step comprises providing the plurality of fund types as at least one fund type being selected from a group consisting essentially of a mutual fund, an index fund, an exchange-traded fund.

9. A method of searching and classifying funds, comprising the steps of:
providing a software program;
entering a list selected from a group consisting essentially of a list of holdings and a list of industry categories into the software program by a user;
searching a database for an item matching the list using the software program, thereby performing a search, and thereby generating search results; and
sorting the search results using the software program, thereby generating a sorted list in a descending matching order.

10. A method, as recited in claim 9, wherein the holdings list comprises at least one of the user's designated publicly traded companies.

11. A method, as recited in claim 9, wherein the list entering step comprises using an online fillable form.

12. A method, as recited in claim 9, wherein the item comprises an element selected from a group consisting essentially of a single fund holding or an industry category.

13. A method, as recited in claim 9, further comprising the step of presenting options to the user for limiting a scope of the search, wherein the scope limiting options comprising fund criteria, the fund criteria comprising at least one element selected from a group consisting essentially of a ratio of any item in relation to a fund, a fund type, a fund expense, a fund net asset value, fund performance data, a minimum initial investment, a front-end load, a purchase fee, a back-end load, an exchange fee, an account fee, fund annual operating expenses, a date for a most recent update, a total expense ratio, and an entity name associated with performing the update.

14. A method, as recited in claim 13, wherein the fund type comprises an element selected from a group consisting essentially of an exchange-traded fund and an index fund.

15. A method, as recited in claim 9, further comprising the step of providing the user with an option for initially designating a parameter selected from a group consisting essentially of a preference and a weight with respect to each holding in the holdings list.

16. A method, as recited in claim 15,
wherein the preference comprises a hierarchy of importance in an order of the holdings list, and
wherein the weight comprises a percentage assigned to each holding in the holdings list.

17. A method, as recited in claim 15, further comprising the step of assigning a desired percentage of importance for each holding by the software program.

18. A method, as recited in claim 15,
wherein the software program accommodates three user levels, and
wherein the three user levels comprise software for an accommodation for a regular user, an accommodation for a fund manager, and an accommodation for a fund program administrator.

19. A method, as recited in claim 18,
wherein the regular user accommodation facilitates performing a fund holding search and performing a category search,
wherein the fund manager accommodation facilitates performing a fund holding search, performing category search, and providing a fund information editing option,
the fund information editing option comprising:
a feature for editing a holding name, a share amount, a category name, and a category amount;
a feature for uploading a spreadsheet containing current fund data; and
a feature for manually editing individual fund data via an online fillable form and submission technique, and
wherein the fund program administrator accommodation facilitates performing a fund holding search, performing a category search, providing a fund information editing option, and providing a user-information editing option,
the fund information editing option comprising:
a feature for editing a holding name, a share amount, a category name, and a category amount;
a feature for uploading a spreadsheet containing current fund data; and
a feature for manually editing individual fund data via an online fillable form and submission technique,
the user-information editing option comprising:
a feature for adding user information;
a feature for deleting user information; and
a feature for editing user information.

20. A method, as recited in claim 9, further comprising the step of collecting data, thereby generating collected data, the collected data comprising at least one element selected from a group consisting essentially of data from corporate quarterly filings that are required by the Securities and Exchange Commission, data from third-party sources, and updateable data from authorized fund management personnel.

21. A method, as recited in claim 20,
wherein the corporate quarterly filings data comprises information gleaned, via a computer, from an Securities and Exchange Commission Form N-Q, the gleaned Form N-Q data being subsequently manually editable for use by the software program,
wherein third-party source data comprises real-time information gleaned from at least one third-party source selected from a group consisting essentially of a Lipper™ service, a Reuters™ service, and a Morningstar™ service, the gleaned third-party source data being in compliance with federal securities regulations, and
wherein the updateable data comprises new data being collected, old data being archived in the database, and interim data being gleaned by directly updating the old data, the interim data comprising at least one element selected from a group consisting essentially of intra-quarterly data, manually gathered data from most recently posted corporate data and a corporate web site.

22. A method, as recited in claim 21, further comprising the step of providing at least one comparison in fund metrics as a function of a plurality of dates using the archived data.

23. A method as recited in claim 9, further comprising a step selected from a group consisting of authorizing a user and registering a user.
